(19) United States
(12) Patent Application Publication
(10) Pub. No.: US 2011/0066329 A1
(43) Pub. Date: Mar. 17, 2011

(54) DRIVING SUPPORT DEVICE

(75) Inventors: Nobuhiko WAKAYAMA, Nagoya-city (JP); Masayuki Imanishi, Okazaki-city (JP)

(73) Assignees: DENSO CORPORATION, Kariya-city (JP); NIPPON SOKEN, INC., Nishio-city (JP)

(21) Appl. No.: 12/878,384

(22) Filed: Sep. 9, 2010

(30) Foreign Application Priority Data
Sep. 11, 2009 (JP) 2009-210768

(51) Int. Cl. G06F 7/00; B62D 15/02

(52) U.S. Cl. 701/42

(57) ABSTRACT

A driving support device includes: an in-vehicle camera for shooting an image toward a driving direction of the vehicle; a display device for displaying the image; a steering wheel angle detector for detecting a steering wheel angle of the vehicle; and a display controller for calculating an expected driving track corresponding to a vehicle width and the steering wheel angle and for controlling the display device to display the expected driving track overlapped on the image. The display controller calculates one steering wheel line, which has a curvature changeable in accordance with the steering wheel angle. The display controller controls the display device to display the one steering wheel line at a center of the expected driving track in a vehicle width direction.

### CROSS REFERENCE TO RELATED APPLICATION

This application is based on Japanese Patent Application No. 2009-210768 filed on Sep. 11, 2009, the disclosure of which is incorporated herein by reference.

### FIELD OF THE INVENTION

The present invention relates to a driving support device for supporting a driving operation of a user.

### BACKGROUND OF THE INVENTION

Conventionally, a technique for supporting a driving operation of a vehicle is well known when a driver parks the vehicle such that a backward image of the vehicle is displayed on a display unit in a compartment of the vehicle, and an expected driving track is displayed and overlapped on the backward image. The expected driving track is changeable in accordance with a steering angle of a steering wheel.

For example, in JP-A-2004-142741 teaches that the expected driving track obtained based on the steering angle is displayed and overlapped on the backward image, and a display marker showing the steering angle status is displayed on a part of a screen.

In JP-A-2005-75015, two expected driving tracks showing expecting tracks of an inner tire and an outer tire in accordance with a steering angle of a steering wheel are shown on an image of a rear side of the vehicle. Further, two extending lines showing a width of the vehicle on a road surface are overlapped on the driving tracks and the rear side image. Furthermore, multiple rough indication lines showing a distance from an end of a rear bumper are overlapped on the driving tracks, the extending lines and the rear side image.

The width between lefty and right expected driving tracks is narrowed as the distance from the vehicle becomes larger because of perspective relationship. Thus, the expected driving tracks corresponding to the vehicle width are shown as a curve even when the steering wheel is not steered, i.e., when the steering angle is zero so as to go straight. Accordingly, the user may roughly recognize the status of the steering wheel based on the display of the expected driving tracks whether the steering wheel position is at a neutral position. In some cases, it is difficult for the user to determine whether the steering wheel position is at the neutral position. Here, the neutral position of the steering wheel means that the steering wheel angle is zero so that the vehicle runs straightly.

In the technique disclosed in JP-A-2004-142741, the steering wheel status is defined as multiple steps, which are described as an arrow or a circle. Thus, the user can recognize the steering wheel status so that the user determines whether the steering wheel position is at the neutral position. However, a region of the screen, on which the display marker such as the arrow and the circle is displayed, is different from a region of the screen, on which the expected driving tracks are displayed. Thus, the user has to watch the expected driving tracks and the display marker, which are displayed on different positions on the screen. Thus, the user operates the steering wheel with watching two separated positions on the screen. It is difficult for the user to return the steering wheel to the neutral position.

In the technique disclosed in JP-A-2005-75015, when the expected driving tracks coincide with the extending lines showing the vehicle width, it is determined that the steering wheel position is at the neutral position. However, since two expected driving tracks in addition to the extending lines showing the vehicle width and the rough indication lines are displayed on the screen, the user may confuse which line the user should watch when the user operates the steering wheel to return to the neutral position. Thus, multiple lines may bother the user when the user operates the steering wheel according to the display of the backward image.

### SUMMARY OF THE INVENTION

In view of the above-described problem, it is an object of the present disclosure to provide a driving support device for supporting a driving operation of a user. The user can operate a steering wheel easily with using the driving support device.

According to an aspect of the present disclosure, a driving support device includes: an in-vehicle camera for shooting an image toward a driving direction of the vehicle; a display device for displaying the image; a steering wheel angle detector for detecting a steering wheel angle of the vehicle; and a display controller for calculating an expected driving track corresponding to a vehicle width and the steering wheel angle and for controlling the display device to display the expected driving track overlapped on the image. The display controller calculates one steering wheel line, which has a curvature changeable in accordance with the steering wheel angle. The display controller controls the display device to display the one steering wheel line at a center of the expected driving track in a vehicle width direction.

In the above device, since the curvature of the steering wheel line is changeable in accordance with the steering wheel angle, the steering wheel line can be displayed to be a straight line when the steering wheel is disposed at a neutral position. Thus, the user can easily determined whether the steering wheel is disposed at the neutral position. Further, the user determines based on the one steering wheel line whether the steering wheel is disposed at the neutral position. Thus, it is easy for the user to watch the one steering wheel line when the user operates the steering wheel to return to the neutral position. Furthermore, the steering wheel line is easily obtained based on the steering wheel angle. Further, the user can watch both of the steering wheel line and the expected driving track simultaneously when the user drives the vehicle. The user can operate a steering wheel easily with using the driving support device.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a parking support device;

FIG. 2 is a diagram showing a display image of a display device; and

FIG. 3 is a diagram showing another display image of the display device.

### DETAILED DESCRIPTION OF THE PREFERRED EMBODIMENTS

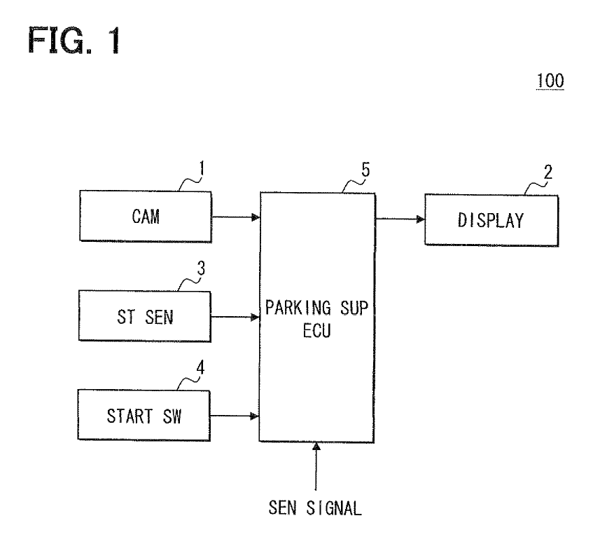

FIG. 1 shows a parking support device 100 as a driving support device for supporting a driving operation of a user. The device 100 is mounted on a vehicle. The device 100 includes an in-vehicle camera 1, a display device 2, a steering wheel sensor 3, a support start switch 4 and a parking support ECU 5, which connects among the camera 2, the device 2, sensor 3 and the switch 4. The camera 2, the device 2, sensor 3 and the switch 4 are coupled with the ECU 5 via an in-vehicle LAN, which is conformed to communication protocol such as CAN (controller area network). Here, the vehicle on which the device 100 is mounted is defined as a subject vehicle.

The camera 1 is mounted at a center of a body of the vehicle. The camera 1 shoots an image of a region of a backward of the vehicle within a predetermined angle range. The light axis of the camera 1 is directed to a road surface on the rear side of the vehicle. For example, the camera 1 is a CCD camera. Image information of the backward image of the vehicle obtained by the camera 1 is input into the ECU 5. The image shot by the camera 1 is defined as the vehicle backward image.

The display device 2 displays the backward image shot by the camera 1. The device 2 is disposed in a compartment of the vehicle. For example, the display device 2 can display a full color image. The device 2 includes, for example, a liquid crystal display, an organic EL display or a plasma display. The display device 2 may be a display unit in an in-vehicle navigation system. Alternatively, the device 2 may be separated from the display unit in the navigation system, and the device 2 may be disposed on an instrumental panel.

The steering wheel sensor 3 includes, for example multiple mechanical gears so that the sensor 3 detects a steering angle of the steering wheel of the vehicle based on the rotation number of each gear. Accordingly, the sensor 3 corresponds to a steering wheel angle detector. The sensor may detect the steering angle with using an infra-red ling or a laser beam.

The passenger as a user of the vehicle instructs to start the parking support function by operating the switch 4. When the switch 4 is turned on and off, the ECU 5 starts or stops to execute the parking support function. For example, the switch 4 may be a hazard switch or the switch 4 may correspond to input of a reverse signal.

The ECU 5 includes a micro computer having a CPU, a ROM, a RAM and a backup RAM. The ECU 5 executes various control programs stored in the ROM according to various information input from the camera 1, the sensor 3 and the switch 4. The ECU 5 executes various processes such as parking support control process. Various sensor signals other than the sensor signal from the sensor 3 may be also input into the ECU 5. For example, a sensor signal from a wheel speed sensor, a sensor signal from a yaw rate sensor, a sensor signal from a shift lever position sensor or the like may be input into the ECU 5.

The parking support control process will be explained. The parking support control process is executed when the switch 4 turns on. When the parking support control process starts, the ECU 5 calculates an expected backward driving line based on the sensor signal sequentially input from the steering wheel sensor 3. The expected backward driving line is an expected line on which the vehicle passes when the vehicle is drive in reverse. Specifically, the expected backward driving line includes a pair of tracks corresponding to a vehicle width. For example, a left expected backward driving line may be a track of a left rear tire, and a right expected backward driving line may be a track of a right rear tire. Thus, the expected backward driving lines may be tracks of tires on a reverse driving direction of the vehicle. Alternatively, right and left expected backward driving lines may correspond to the vehicle width. Alternatively, right and left expected backward driving lines may correspond to track curves of an utmost outer portion and an utmost inner portion of the vehicle.

The expected backward driving line may be obtained by a conventional method. For example, when the vehicle speed is low such as equal to or less than 10 km/h, the expected backward driving line is sequentially obtained from a turning radius R in accordance with the steering wheel angle. The turning radius R is calculated from a relationship of R=L/tan θ. Here, a turning center O is disposed on an extending line of a rear wheel axis of the vehicle. θ represents the steering wheel angle, and L represents a wheelbase. Alternatively, the track curve of the utmost outer portion of the vehicle may be calculated based on the steering wheel angle detected by the sensor 3 and the vehicle speed detected by the wheel speed sensor (not shown). The calculated track curve is modified to pass through each of a left rear corner and a right rear corner of the vehicle. Alternatively, the calculated track curve may be modified to pass through each of a left rear wheel and a right rear wheel. Alternatively, the track curves of the utmost outer portion and the track curve of the utmost inner portion may be calculated based on the vehicle speed detected by the wheel speed sensor and the steering wheel angle detected by the sensor 3. Alternatively, the expected backward driving line may be calculated based on the steering wheel angle detected by the sensor 3, the vehicle speed detected by the wheel speed sensor and a yaw rate of the vehicle detected by a yaw rate sensor.

The ECU 5 calculates the expected backward driving line and further calculates expected backward driving area, which is a region sandwiched with the right and left expected backward driving lines as right and left expected lines. Further, the ECU 5 calculates one steering wheel angle line, which passes through a center of the vehicle along with the vehicle width, based on the steering wheel angle. The steering wheel angle line may pass through the vehicle axle. The steering wheel line is a straight line having a curvature of zero when the steering wheel angle is a neutral angle, i.e., when the steering wheel is at the neutral position. The curvature of the steering wheel angle line becomes larger as the steering wheel turns from the neutral position largely. The neutral position of the steering wheel may be defined as a steering wheel angle at which a pulse difference or the left wheel is substantially equal to the right wheel when the vehicle speed is equal to or larger than a predetermined vehicle speed such as 10 km/h. Thus, the neutral position of the steering wheel may be obtained by a conventional method.

The steering wheel line is obtained by the following method. For example, the steering wheel angle and the curvature of the steering wheel line are preliminary correlated such that the curvature becomes zero when the steering wheel angle is at the neutral position, and the curvature becomes large when the steering wheel turns largely from the neutral position. One steering wheel line passing through the center of the vehicle width of the vehicle may be calculated based on the steering wheel angle and the relationship between the steering wheel angle and the curvature.

Based on the turning center O and the turning radius R, the steering wheel line may be obtained from an expected track, through which the center of the vehicle width passes. Alternatively, the steering wheel line may be obtained from the expected backward driving line. For example, coordinates of the center line between the right and left expected backward driving lines are calculated based on the coordinates of the expected backward driving lines arranged in the vehicle width direction. The center line provides the steering wheel line. Thus, when the steering wheel line is calculated by the same method as the expected backward driving line, or when the steering wheel line is calculated based on the expected backward driving line, the curvature of the steering wheel line has characteristics similar to the characteristics of the curvature of the expected backward driving line. Even when both of the steering wheel line and the expected backward driving line are displayed, visual quality of the image becomes high. When the ECU 5 calculates the expected backward driving line, the expected backward driving area and the steering wheel line, the coordinates of the expected backward driving line, the expected backward driving area and the steering wheel line are obtained in the coordinate system of a ground surface. In the present embodiment, the expected backward driving line and the steering wheel line are calculated based on the turning center O and the turning radius R.

Then, in a converting process, the coordinates of the expected backward driving line, the coordinates of the expected backward driving area and the coordinates of the steering wheel line are converted to the coordinate system of the rear image of the vehicle. In the converting process, the coordinates of the expected backward driving line, the coordinates of the expected backward driving area and the coordinates of the steering wheel line are converted with using a conventional coordinate converting method.

The ECU 5 controls the display device 2 to display the backward image and to overlap the expected backward driving line and the expected backward driving area based on the expected backward driving line, the expected backward driving area and the steering wheel line, which are converted to the coordinate system same as the backward image. Further, the ECU 5 controls the display device 2 to display the steering wheel line overlapped on the backward image such that the steering wheel line is disposed at the center of the expected backward driving area in the vehicle width direction. Thus, the ECU 5 corresponds to the display controller. The expected backward driving line and the expected backward driving area are integrally displayed on the backward image. The expected backward driving line and the expected backward driving area, which are integrated, correspond to an expected driving track. Since the dimensions of the expected driving track in the width direction are determined according to the expected backward driving line corresponding to the vehicle width, the expected driving track corresponds to the vehicle width.

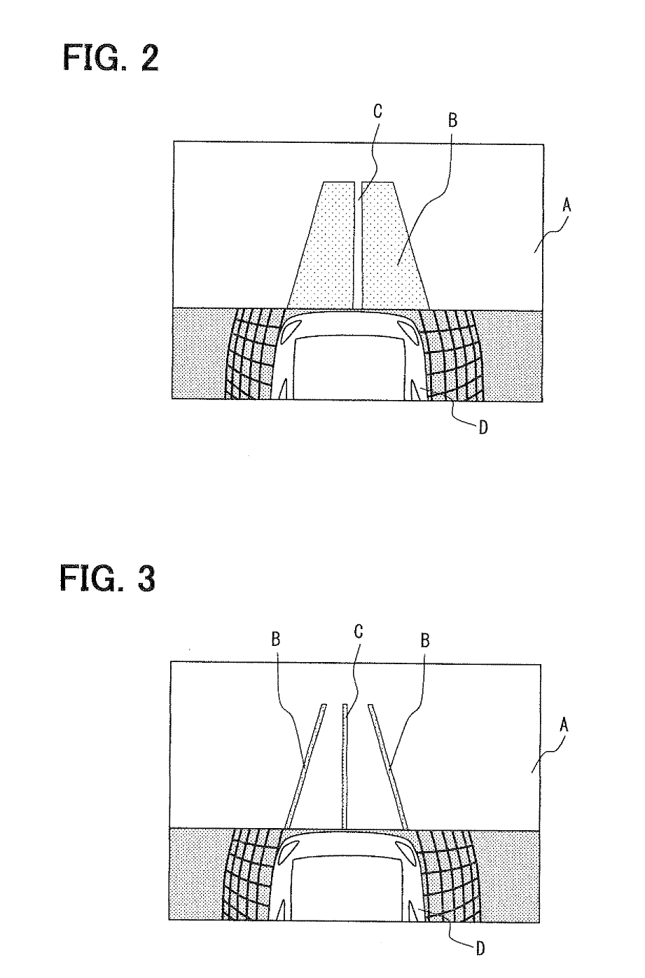

The display mode of the expected driving track and the steering wheel line on the display device 2 will be explained with reference to FIG. 2. FIG. 2 shows an image of the display device 2. In FIG. 2, A represents the backward image of the vehicle, B represents the expected driving track, and C represents the steering wheel line. D represents an image of the rear side of the body of the vehicle.

The range of the expected driving track B is colored by a predetermined color in order to distinguish the expected driving track B from the backward image A. In this embodiment, although the range of the expected driving track B is colored by a predetermined color in order to distinguish the expected driving track B from the backward image A, it is no limited to this feature. The feature of the expected driving track B may be different as long as the expected driving track B is distinguishable from the backward image. For example, the range of the expected driving track B may be shaded or hatched.

The steering wheel line C is colored by another predetermined color different from the expected driving track B in order to distinguish the steering wheel line C from the expected driving track B. Further, the ECU 5 controls the display device 2 to display the steering wheel line such that the steering wheel line is disposed at the center of the expected driving track. Here, the different color means that at least one of the color phase, the color saturation and the brightness in the steering wheel line C is different from the expected driving track B. In this embodiment, the color of the steering wheel line C is different from the expected driving track B so as to distinguish the steering wheel line C from the expected driving track B. It is not limited to this feature of the steering wheel line C. The display mode of the steering wheel line C may be different from this feature as long as the steering wheel line C is distinguishable from the expected driving track B. For example, the steering wheel line C may be displayed such that a slit is formed at the center of the expected driving track B in the vehicle width direction.

Thus, in the present embodiment, the steering wheel line is a straight line having the curvature of zero when the steering wheel angle is at the neutral position. The curvature of the steering wheel line increases as the steering wheel angle becomes larger from the neutral position. The steering wheel line is displayed at the center of the expected driving track B. Thus, the steering wheel line is displayed to be straight so that the steering wheel line is perpendicular to the vehicle width direction when the steering wheel is disposed at the neutral position. Thus, the user can recognize intuitively whether the steering wheel line is a straight line perpendicular to the vehicle width direction or a curve. The user can determine easily whether the steering wheel is at the neutral position.

Here, in the technique disposed in JP-A-2004-142741, the steering wheel status is defined as multiple steps such as seven steps, which are described as a display marker such as an arrow or a circle. Thus, the user roughly recognizes the steering wheel status. Accordingly, when the steering wheel is disposed near the neutral position, it is difficult for the user to determine how much the user turns the steering wheel to return to the neutral position. Thus, it is difficult to return the steering wheel at the neutral position. However, in the present embodiment, the curvature of the steering wheel line is changed in accordance with the steering wheel angle. Thus, the user can easily determine based on the curving degree of the steering wheel line as an indicator how much the user turns the steering wheel to return to the neutral position.

Since the user determines based on one steering wheel line whether the steering wheel is disposed at the neutral position, the image on the display device 2, in which the backward image and the steering wheel line are overlapped, is simplified. Thus, the user easily recognizes which image the user should watch when the user operates the steering wheel to return to the neutral position.

Further, a calculation process for obtaining the steering wheel line is performed together with a calculation process for obtaining the expected backward driving line. Thus, the steering wheel line is easily obtained. Thus, an additional cost and an additional process load for providing easily determination for the user to determine whether the steering wheel is disposed at the neutral position are reduced. Even when the steering wheel line is obtained based on the expected backward driving line, the steering wheel line is calculated from the calculated expected backward driving line. Thus, the steering wheel line is easily obtained. Thus, an additional cost and an additional process load for providing easily determination for the user to determine whether the steering wheel is disposed at the neutral position are reduced.

In the present embodiment, one steering wheel line is displayed at the center of the expected driving track in the width direction. The steering wheel line provides to determine whether the steering wheel is disposed at the neutral position. Thus, the user drives the vehicle while the user watches the steering wheel line and the expected driving track corresponding to the width of the vehicle simultaneously. Thus, the parking support device 100 for supporting the user to operate the steering wheel to the neutral position easily is obtained. The parking support device 100 corresponds to the driving support device.

Further, since the expected backward driving area sandwiched with the right and left expected backward driving lines is integrated with the expected backward driving lines, and the expected backward driving area and the expected backward driving lines integrated as the expected backward driving track are displayed to be distinguishable from the backward image. The expected backward driving track is shown as an area not a line. Accordingly, the user can recognize an expected course, through which the vehicle runs.

The ECU 5 determines based on the steering wheel angle detected by the steering wheel sensor 3 whether the steering wheel is disposed at the neutral position. When the ECU 5 determines that the steering wheel is disposed at the neutral position, the color of the steering wheel line may be changed. Specifically, when the steering wheel angle detected by the sensor 3 corresponds to the neutral position of the steering wheel, the ECU 5 determines that the steering wheel is disposed at the neutral position. When the ECU 5 determines that the steering wheel is disposed at the neutral position. In this case, the ECU 5 corresponds to a neutral position determination unit. Here, when the color of the steering wheel line is changed, at least one of the color phase, the color saturation and the brightness in the steering wheel line may be changed.

In the present embodiment, the expected backward driving area and the expected backward driving lines are integrated so that the expected backward driving track is formed, and the expected backward driving track us displayed on the display device 2. It is not limited to this feature. For example, the expected backward driving area may not be displayed, and only the expected backward driving lines may be displayed as the expected backward driving track.

Here, the display mode of the expected backward driving lines will be explained with reference to FIG. 3 when the expected backward driving area is not displayed, and the right and left expected backward driving fines is displayed as the expected backward driving track. FIG. 3 shows an example of the image on the display device 2. In FIG. 3, A represents the backward image of the vehicle, B represents the expected driving track, and C represents the steering wheel line. D represents an image of the rear side of the body of the vehicle. The right and left expected driving tracks B are displayed on the device 2 to have a predetermined color so as to distinguish the tracks from the backward image. The steering wheel line C is displayed on the device 2 to be disposed at the center of the expected driving tracks B in the width direction.

In the above embodiment, the parking support ECU 5 starts and stops to execute the parking support control process when the user switches the switch 4 on and off. It is not limited to this feature. For example, the ECU 5 may start to execute the parking support control process when the ECU 5 determines based on the vehicle speed detected by the wheel speed sensor and the shift lever position detected by the shift lever position sensor that the shift lever position is disposed at a reverse position “R,” and the vehicle speed is equal to or smaller than a predetermined speed such as 10 km/h. The ECU 5 may stop to execute the parking support control process when the ECU 5 determines that the shift lever position is disposed at a parking position “P.”

In the present embodiment, the driving support device is the parking support device so that the device supports the user when the user drives the vehicle reversely to park the vehicle. It is not limited to this feature. For example, the driving support device is the parking support device so that the device supports the user when the user drives the vehicle forward to park the vehicle. In this case, the camera 1 is disposed at the center of the front side of the body of the vehicle so that the camera 1 shoots an image expanding within a predetermined angle range in front of the vehicle. The ECU 5 controls the display device 2 to display the expected driving track according to the steering wheel angle and the steering wheel line disposed at the center of the expected driving track in the width direction, which are overlapped on the forward image of the vehicle. The forward image is shot by the camera 1.

The above disclosure has the following aspects.

According to an aspect of the present disclosure, a driving support device includes: an in-vehicle camera for shooting an image toward a driving direction of the vehicle; a display device for displaying the image; a steering wheel angle detector for detecting a steering wheel angle of the vehicle; and a display controller for calculating an expected driving track corresponding to a vehicle width and the steering wheel angle and for controlling the display device to display the expected driving track overlapped on the image. The display controller calculates one steering wheel line, which has a curvature changeable in accordance with the steering wheel angle. The display controller controls the display device to display the one steering wheel line at a center of the expected driving track in a vehicle width direction.

In the above device, since the curvature of the steering wheel line is changeable in accordance with the steering wheel angle, the steering wheel line can be displayed to be a straight line when the steering wheel is disposed at a neutral position. Thus, the user can easily determined whether the steering wheel is disposed at the neutral position. Further, the user determines based on the one steering wheel line whether the steering wheel is disposed at the neutral position. Thus, it is easy for the user to watch the one steering wheel line when the user operates the steering wheel to return to the neutral position. Furthermore, the steering wheel line is easily obtained based on the steering wheel angle. Further, the user can watch both of the steering wheel line and the expected driving track simultaneously when the user drives the vehicle. The user can operate a steering wheel easily with using the driving support device.

Alternatively, the expected driving track may include right and left expected driving lines and an expected driving area. The expected driving area is sandwiched between the right and left expected driving lines. The right and left expected driving lines and the expected driving area are integrally displayed to be distinguishable from the image. The one steering wheel line is displayed to be distinguishable from the expected driving area. In this case, the expected driving track is shown as an area. Thus, the user can easily recognize an expected driving course.

Alternatively, the expected driving track may include right and left expected driving lines. The right and left expected driving lines are displayed to be distinguishable from the image.

Alternatively, the driving support device may further include: a steering position determining unit for determining based on the steering wheel angle whether the steering wheel is disposed at a neutral position. The display controller controls the display device to change a color of the steering wheel line when the steering position determining unit determines that the steering wheel is disposed at the neutral position. In this case, the user can easily determine whether the steering wheel is disposed at the neutral position.

Further, the expected driving track may include right and left expected driving lines. The right expected driving line is an expected driving trace of a right side tire of the vehicle, and the left expected driving line is an expected driving trace of a left side tire of the vehicle. The curvature of the steering wheel line is zero so that the steering wheel line is a straight line when the steering wheel is disposed at the neutral position. The curvature of the steering wheel line increases when the steering wheel is turned largely from the neutral position. Furthermore, the expected driving track may further include an expected driving area. The expected driving area is sandwiched between the right and left expected driving lines. The right and left expected driving lines and the expected driving area are integrally displayed to be distinguishable from the image. The one steering wheel line is displayed to be distinguishable from the expected driving area.

Alternatively, the expected driving track may include right and left expected driving lines. The right expected driving line is an expected driving trace of a right side of a body of the vehicle, and the left expected driving line is an expected driving trace of a left side of the body of the vehicle. The curvature of the steering wheel line is zero so that the steering wheel line is a straight line when the steering wheel is disposed at the neutral position. The curvature of the steering wheel line increases when the steering wheel is turned largely from the neutral position.

Alternatively, the expected driving track may include a pair of expected driving lines. One of the pair of expected driving lines is an expected driving trace of an utmost outer portion of a body of the vehicle, and the other of the pair of expected driving lines is an expected driving trace of an utmost inner portion of the body of the vehicle. The curvature of the steering wheel line is zero so that the steering wheel line is a straight line when the steering wheel is disposed at the neutral position. The curvature of the steering wheel line increases when the steering wheel is turned largely from the neutral position.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A driving support device comprising:
an in-vehicle camera for shooting an image toward a driving direction of the vehicle;
a display device for displaying the image;
a steering wheel angle detector for detecting a steering wheel angle of the vehicle; and
a display controller for calculating an expected driving track corresponding to a vehicle width and the steering wheel angle and for controlling the display device to display the expected driving track overlapped on the image,
wherein the display controller calculates one steering wheel line, which has a curvature changeable in accordance with the steering wheel angle, and
wherein the display controller controls the display device to display the one steering wheel line at a center of the expected driving track in a vehicle width direction.

2. The driving support device according to claim 1,
wherein the expected driving track includes right and left expected driving lines and an expected driving area,
wherein the expected driving area is sandwiched between the right and left expected driving lines,
wherein the right and left expected driving lines and the expected driving area are integrally displayed to be distinguishable from the image, and
wherein the one steering wheel line is displayed to be distinguishable from the expected driving area.

3. The driving support device according to claim 1,
wherein the expected driving track includes right and left expected driving lines, and
wherein the right and left expected driving lines are displayed to be distinguishable from the image.

4. The driving support device according to claim 1, further comprising:
a steering position determining unit for determining based on the steering wheel angle whether the steering wheel is disposed at a neutral position,
wherein the display controller controls the display device to change a color of the steering wheel line when the steering position determining unit determines that the steering wheel is disposed at the neutral position.

5. The driving support device according to claim 4,
wherein the expected driving track includes right and left expected driving lines,
wherein the right expected driving line is an expected driving trace of a right side tire of the vehicle, and the left expected driving line is an expected driving trace of a left side tire of the vehicle,
wherein the curvature of the steering wheel line is zero so that the steering wheel line is a straight line when the steering wheel is disposed at the neutral position, and
wherein the curvature of the steering wheel line increases when the steering wheel is turned largely from the neutral position.

6. The driving support device according to claim 5,
wherein the expected driving track further includes an expected driving area,
wherein the expected driving area is sandwiched between the right and left expected driving lines,
wherein the right and left expected driving lines and the expected driving area are integrally displayed to be distinguishable from the image, and
wherein the one steering wheel line is displayed to be distinguishable from the expected driving area.

7. The driving support device according to claim 4,
wherein the expected driving track includes right and left expected driving lines,
wherein the right expected driving line is an expected driving trace of a right side of a body of the vehicle, and the left expected driving line is an expected driving trace of a left side of the body of the vehicle,
wherein the curvature of the steering wheel line is zero so that the steering wheel line is a straight line when the steering wheel is disposed at the neutral position, and
wherein the curvature of the steering wheel line increases when the steering wheel is turned largely from the neutral position.

8. The driving support device according to claim 7,
wherein the expected driving track further includes an expected driving area,
wherein the expected driving area is sandwiched between the right and left expected driving lines,
wherein the right and left expected driving lines and the expected driving area are integrally displayed to be distinguishable from the image, and
wherein the one steering wheel line is displayed to be distinguishable from the expected driving area.

9. The driving support device according to claim 4,
wherein the expected driving track includes a pair of expected driving lines,
wherein one of the pair of expected driving lines is an expected driving trace of an utmost outer portion of a body of the vehicle, and the other of the pair of expected driving lines is an expected driving trace of an utmost inner portion of the body of the vehicle,
wherein the curvature of the steering wheel line is zero so that the steering wheel line is a straight line when the steering wheel is disposed at the neutral position, and
wherein the curvature of the steering wheel line increases when the steering wheel is turned largely from the neutral position.

10. The driving support device according to claim 9,
wherein the expected driving track further includes an expected driving area,
wherein the expected driving area is sandwiched between the pair of expected driving lines,
wherein the pair of expected driving lines and the expected driving area are integrally displayed to be distinguishable from the image, and
wherein the one steering wheel line is displayed to be distinguishable from the expected driving area.
